(19) United States
(12) Patent Application Publication
(10) Pub. No.: US 2022/0127878 A1
(43) Pub. Date: Apr. 28, 2022

(54) BIDIRECTIONALLY OPERATING WARFARE LOCK MECHANISM

(71) Applicant: FNSS SAVUNMA SÍSTEMLERÍ A.S., GÖLBASI (TR)

(72) Inventors: Cihan Emre ULUISIK, Çankaya (TR); Ali ABAY, GÖLBASI (TR); Nihan ÇERÇîOSLU, GÖLBASI (TR)

(21) Appl. No.: 17/275,682

(22) PCT Filed: Apr. 21, 2020
(86) PCT No.: PCT/TR2020/050336

§ 371 Date: Mar. 12, 2021

(30) Foreign Application Priority Data
Apr. 26, 2019 (TR) 2019/06199

(51) Int. Cl. E05B 15/10; E05C 1/00; E05C 1/04; E05B 83/00

(52) U.S. Cl. CPC E05B 15/101; E05B 83/01; E05C 1/04; E05C 1/004

(57) ABSTRACT

The present invention relates to a bidirectionally operating warfare lock mechanism (C) that prevents external interference (opening/unlocking) to hatches in military vehicles (A) during combat. The present invention particularly relates to a bidirectionally operating warfare lock mechanism (C) comprising a lock operating mechanism (100) that is connected to the vehicle (A) and that allows for opening and locking the hatch (B) when the user moves the lock lever (110) to P1 (161) and P2 (162) receptacles, and further comprising a lock bolt mechanism (200) that can be easily mounted by being rotated 180° around its axis without making any changes in the design, thereby allowing for being used in always-open or always-closed (locked) configurations according to the desired scenario.

### TECHNICAL FIELD OF THE INVENTION

The present invention relates to a bidirectionally operating combat lock mechanism that prevents external interference (opening/unlocking) to hatches in military vehicles during combat.

The present invention particularly relates to a bidirectionally operating combat lock mechanism comprising a lock operating mechanism that is connected to the vehicle and that allows for locking and unlocking the hatch when the user moves the lock lever to P1 and P2 receptacles, and further comprising a lock bolt mechanism that can be easily mounted by being rotated 180° around its axis without making any changes in the design, thereby allowing for being used in normally open or normally closed or always-closed (locked) configurations according to the desired scenario.

### STATE OF THE ART

Nowadays, many different types of military vehicles are designed and manufactured for purposes of assault, defense and personnel transportation in the defense industry. One of the many subjects that are of vital importance in the design process of such vehicles is to ensure that the person may perform necessary operations easily and swiftly in areas of need in the event of combat or emergencies. In military vehicles, various lock mechanisms are utilized that prevent any external interference (unlocking/opening) to the hatches during combat, and that may be locked and unlocked only from the inside. Conventional warfare lock mechanism used in such vehicles are generally manufactured as two different lock mechanisms having different design patterns in available applications, and they are either always open or always closed depending on the need and the place of use.

Normally Open Lock Mechanisms: normally open lock mechanisms are generally kept in the continuously open setting under normal circumstances, hatches may be opened easily from the outside, however, they may be switched to the respective locking position upon user intervention, thereby preventing the hatches from being opened from the outside.

Normally Closed Lock Mechanisms: normally closed lock mechanisms maintain a continuous closed setting, thereby keeping the hatches in the locked position at all times, the lock mechanism may be switched to unlocked position upon the user's intervention from the inside and accordingly, the hatches may be opened from the outside.

In the state of the art, different lock mechanisms are required in cases where both of the configurations are utilized in a military vehicle. This constitutes a difference in components, thereby creating complexity in the assembly and installation processes, diversity in manufacturing, difficulties in storage as well as creating various challenges in the supply of repair and replacement parts, and accordingly causes incremental costs. Furthermore, this causes implementing different maintenance procedures for different types of lock mechanisms.

These lock mechanisms which are commonly utilized in the state of the art, necessitate changing the designs in respective assembly and installation positions due to having different structures.

Lock mechanisms used in military vehicles in the state of the art must maintain their durability during combat, and feature a structure that ensures a certain extent of insulation as well as isolation to keep hazardous chemicals from entering the interior of the vehicle, in respect thereof, standard lock mechanisms that are commercially available do not feature characteristics suitable for being used in military vehicles.

Consequently, the need for a novel bidirectionally operating warfare lock mechanism that is both cost-efficient and practical as well as the inability of the available solutions necessitated making an improvement in the relevant technical field in order to provide solution and to overcome the aforementioned problems existing in the state of the art.

### OBJECTS OF THE INVENTION

Therefore, the present invention relates to a bidirectionally operating warfare lock mechanism that prevents external interference (opening/unlocking) to hatches in military vehicles during combat, and that is developed for the purpose of eliminating the aforementioned disadvantages and providing further advantages to the relevant technical field.

The main object of the present invention is to combine conventional warfare lock mechanisms that are either in always-open or always-closed configurations, with a newly designed single warfare lock mechanism that is capable of operating bidirectionally. Thus, disadvantages including assembly and installation complexity, manufacturing diversity, storage difficulty, and the replacement part supply are eliminated.

Another object of the present invention is to provide a bidirectionally operating warfare lock mechanism that may be used in either always-open or always-closed configurations according to the desired scenario by mounting the warfare lock mechanism by rotating it 180° on its axis by means of the inventive bidirectionally operating warfare lock mechanism that comprises of two main components which are the lock operating mechanism and lock bolt mechanism.

Another object of the present invention is to provide a bidirectionally operating warfare lock mechanism that does not require any design changes for the installation process.

Yet another object of the present invention is to provide a bidirectionally operating warfare lock mechanism that separates intravehicular and extravehicular atmospheres by means of the sealing elements used in the structure of the inventive bidirectionally operating warfare lock mechanism.

Yet another object of the present invention is to provide a bidirectionally operating warfare lock system that eliminates any potential complexity and confusion in vehicles to be used by responding to different needs with a single design.

The present invention is a bidirectionally operating warfare lock mechanism that prevents any potential external interference (opening/unlocking) to hatches in military vehicles during combat in order to achieve objects mentioned above and will become clear by means of the detailed description provided below. Accordingly, a bidirectionally operating warfare lock mechanism is provided, wherein said lock mechanism comprises;
a lock operating mechanism (100) that is connected to the vehicle (A) and that allows for locking and unlocking the hatch (B) when the user moves the lock lever (110) to the P1 (161) and P2 (162) receptacles;
a lock bolt mechanism (200) that is easily mounted by rotating said lock bolt mechanism (200) by 180° on its axis without making any changes in the design, thereby enabling the use of the inventive lock mechanism in either always-open or always-closed (locked) configurations based on the desired scenario.

Structural and characteristic features of the present invention, as well as all advantages thereof, shall become clear by means of the figures and the detailed description provided by making references to said figures, therefore the necessary evaluation should be conducted by taking said figures and the detailed description into consideration.

### DESCRIPTION OF THE FIGURES

FIG. 1 illustrates the disassembled view of the inventive bidirectionally operating warfare lock mechanism.

FIG. 2 illustrates the inventive bidirectionally operating warfare lock mechanism and the view in which the hatch is mounted on the vehicle.

FIG. 3 illustrates the always-open configuration of the inventive bidirectionally operating warfare lock mechanism.

FIG. 4 illustrates the always-closed configuration of the inventive bidirectionally operating warfare lock mechanism.

FIG. 5 illustrates the back and forth motion of the lock pin in the inventive bidirectionally operating warfare lock mechanism.

FIG. 6 illustrates the view in which the inventive bidirectionally operating warfare lock mechanism is mounted on the hatch.

FIG. 7 illustrates the sectional view of the inventive bidirectionally operating warfare lock mechanism.

FIG. 8 illustrates the sectional view of the always-open configuration of the inventive bidirectionally operating warfare lock mechanism.

FIG. 9 illustrates the view in which the always-open configuration of the inventive bidirectionally operating warfare lock mechanism is in locked formation.

FIG. 10 illustrates the sectional view of the always-closed configuration of the inventive bidirectionally operating warfare lock mechanism.

FIG. 11 illustrates the view in which the always-closed configuration of the inventive bidirectionally operating warfare lock mechanism is in locked formation.

### REFERENCE NUMERALS

A. Vehicle
B. Hatch
C. Warfare Lock Mechanism
100. Lock Operating Mechanism
110. Lock Lever
120. Connection Element
130. Lock Pin
131. Channel
132. Gap
133. Right End Gap
134. Recess
140. Fastening Screw
150. O-Ring
160. Lock Body
161. P1 Receptacle
162. P2 Receptacle
163. Lock Body Interior
170. Gasket
180. Welding Flange
190. Retaining Ring
200. Lock Bolt Mechanism
210. Lock Bolt
211. Lock Bolt End
220. Compression Spring
230. Big Bushing
240. Locking Body
241. Body Interior
242. Slot Holes
250. Small Bushing
260. Lock Seat

### DETAILED DESCRIPTION OF THE INVENTION

In the detailed description provided herein, preferred embodiments of the inventive bidirectionally operating warfare lock mechanism (C) are disclosed only to ensure a better understanding of the subject and without imposing any limiting effects.

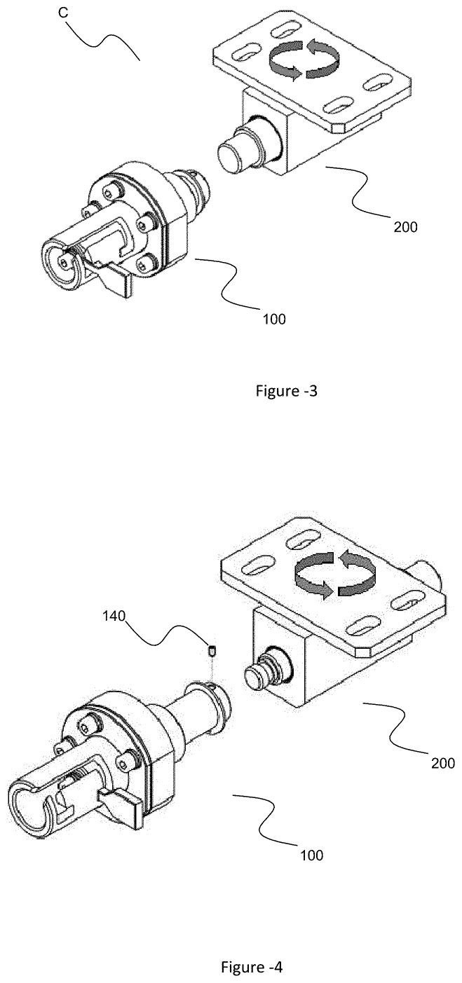

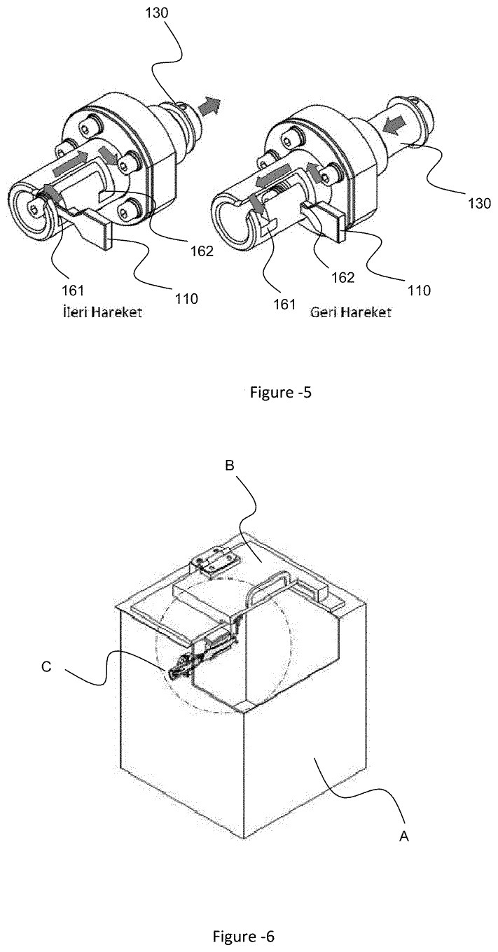

FIG. 2 illustrates a hatch (B) located on a military vehicle (A). A warfare lock mechanism (C) that may be used bidirectionally in two different configurations (always-open or always-closed), and that prevents any external interference (opening/unlocking) to the hatches (B) during combat, is utilized in military vehicles (A). The warfare lock mechanism illustrated in FIG. 3, FIG. 4 and FIG. 5 is designed to be composed of two main components which are the lock operating mechanism (100) and the lock bolt mechanism (200).

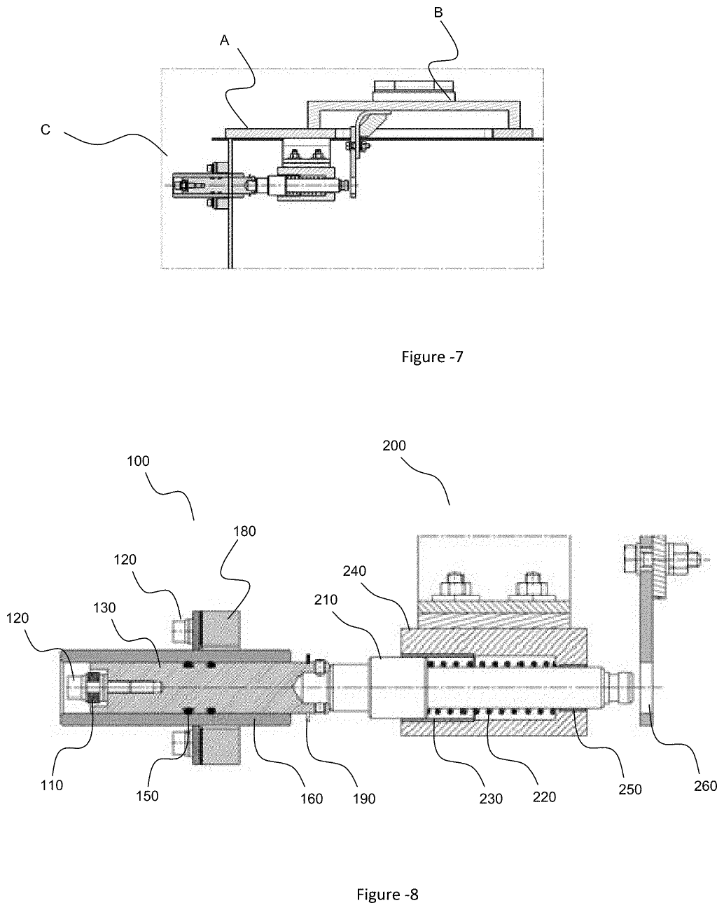

In FIG. 6 and FIG. 7, the inventive bidirectionally operating warfare lock mechanism (C) is sectionally illustrated on the hatch (B). The lock bolt mechanism (200) may be mounted by being rotated 180° on its axis and thus, it may be used in always-open or always-closed configurations according to the desired scenario. The lock bolt mechanism (200) features a structure that allows it to be mounted easily without making any changes in the design even though it is rotated around its axis.

In both scenarios, access to the warfare lock (C) assembly is ensured by means of the lock lever (110) and only from the inside of the vehicle when the hatches (B) that are desired to be locked in the vehicle (A) are closed. Movements of the lock lever (110) are confined and limited within the channels created on the lock body (160).

Insulation between the interior and the exterior of the vehicle (A) is ensured by using sealing elements; O-ring (150) and gasket (170) in moving parts that constitute the warfare lock (C) assembly and in the mounting positions. Thus, the safety of the personnel is improved by preventing any potential chemical leaks that may enter the vehicle through the warfare lock mechanism (C) during combat.

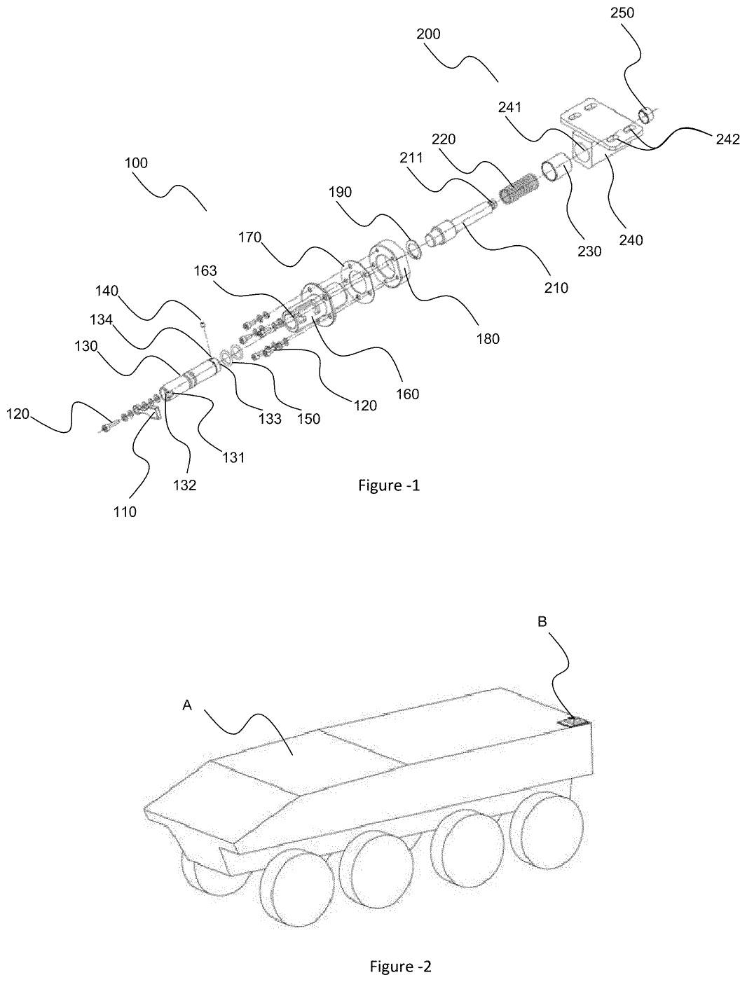

FIG. 1 illustrates the disassembled view of the inventive bidirectionally operating warfare lock mechanism (C). The lock lever (110) is passed through the channel (132) of the lock pin (130) and seated in the gap (131) located at the end thereof, is fixed to the lock pin (130) by means of the connection elements (120) and is controlled manually. The lock pin (130) moves within the interior (163) of the lock body (160) and locks and unlocks the hatch (B) by driving the lock bolt (210). O-rings (150) are connected to the lock pin (130) in order to ensure the sealing. The end (211) of the lock bolt (210) is connected to the right end gap (133) of the lock pin (130) and it is fixed to the recess (134) by means of the fastening screw (140) when the warfare lock (C) assembly is desired to be used in the always-closed configuration. The main carrier component for the lock operating mechanism (100) is the lock body (160), and it comprises P1 (161) and P2 (162) receptacles in order to ensure that the lock lever (110) opens and closes the lock in a controlled manner. Welding Flange (180) allows the lock operating mechanism (100) to be fixed to the vehicle (A). A gasket (170) which ensures the sealing, is positioned between the lock body (160) and the welding flange (180), and these are fixed to one another by means of the connection elements. The main component of the lock bolt mechanism (200) herein is the locking body (240). Said locking body (240) ensures the movement of the lock bolt (210) by means of bearing it. Symmetrical slot holes (242) are positioned there for assembly and mounting operations, thus, it may be mounted easily by merely rotating it 180° around its axis. The lock bolt (210) moves back and forth within the interior (241) of the locking body (240) and locks the hatch (B) by getting seated inside the lock seat (260) that is connected to the hatch (B). The compression spring (220) positioned between the locking body (240) and the lock bolt (210) continuously tries to push the lock bolt (210) out of the locking body (240). Big (230) and small (250) bushings positioned within the interior (241) of the locking body (240) prevent the lock bolt (210) from wearing out.

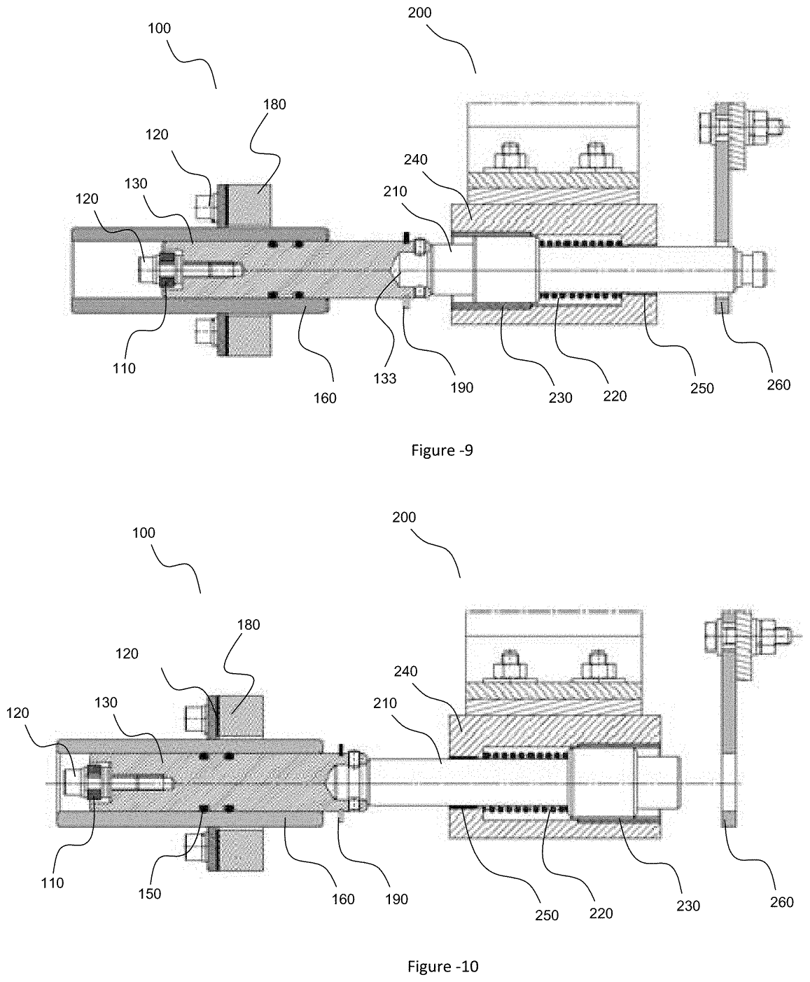

In the scenario illustrated in FIG. 8 and FIG. 9 in which the lock mechanism (C) assembly is mounted on the vehicle (A) in the always-open configuration: As the compression spring (220) is inclined to push the lock bolt (210) to the left, the lock bolt (210) leans directly against the lock pin (130), thereby maintaining the always-open configuration of the warfare lock (C).

The lock lever (110) is pushed upward, forward and downward subsequently from the P1 receptacle (161) and moved to the P2 receptacle (162) position (forward movement). Thus, the lock pin (130) exceeds the pressing force of the compression spring (220), thereby allowing the lock bolt (210) to enter the lock seat (260). The hatches cannot be unlocked and opened from the outside since the lock bolt (210) that inserted to the lock seat (260) connected to the hatch (B), locked the hatches (B).

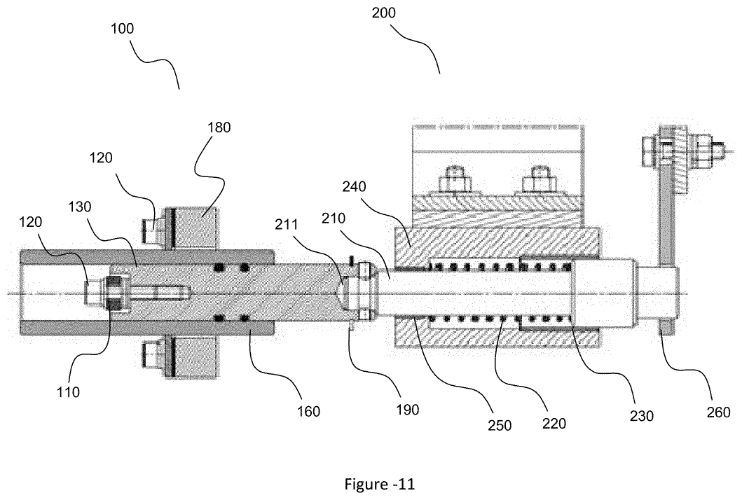

In the scenario illustrated in FIG. 10 and FIG. 11 in which the lock mechanism (C) assembly is mounted on the vehicle (A) in the always-closed configuration: This time, the compression spring (220) is inclined to push the lock bolt (210) to the right as the lock bolt mechanism (200) is mounted by being rotated 180° around its axis. In that case, the connection between the lock bolt (210) and the lock pin (130) is established (mounted) by means of the fastening (140) screw. The lock bolt (210) which is inclined to move towards the right side, enters to the lock seat (260) by drawing the lock pin (130) together by means of the compression spring (220). Thus, it gets locked to the lock seat (260) connected to the hatches (B), thereby preventing the hatches (B) from being opened from the outside. In the scenario disclosed herein, the lock lever (110) that is perpetually kept inside the P2 receptacle (162) (locked) is moved upward, back and subsequently downward to the P1 receptacle (161) in order to unlock the hatches (B) (reverse movement). Thus, the lock pin (130) exceeds the pressing force of the compression spring (220), thereby ensuring that the lock bolt (210) which is connected to the fastening screw (140), is pulled out of the lock seat (260).

The protection scope of this application is determined in the pending patent claims, therefore, the present invention cannot be construed to be limited to the disclosure provided above for illustrative purposes, moreover, it is obvious that a person skilled in the art may set forth the novelty disclosed in the present invention, by utilizing the embodiments of similar characteristics and/or by implementing the respective embodiment in the fields with similar purposes used in the relevant art. Therefore, it is quite obvious that such embodiments will be deprived of the novelty criteria and the criteria for surpassing the state of the art in particular.

1. A bidirectionally operating combat lock mechanism (C) that prevents external interference (opening/unlocking) to hatches in military vehicles (A) during combat; characterized by comprising;
at least one lock operating mechanism (100) that is connected to the vehicle (A) and that allows for locking and unlocking the hatch (B) when the user moves the lock lever (110) to the P1 (161) and P2 (162) receptacles;
at least one lock bolt mechanism (200) that is easily mounted by being rotated 180° around its axis without making any changes in the design, thereby enabling the use of the lock mechanism in either normally open or normally closed (locked) configurations based on the desired scenario.

2. Lock operating mechanism (100) according to claim 1, characterized in that; it comprises a lock body (160) that allows the lock pin (130) to move within the interior (163) therein by bearing it, and that contains the P1 (161) and P2 (162) receptacles in which the lock lever (110) connected to the lock pin (130) is positioned so as to keep the hatch (B) in locked and open configurations.

3. Lock operating mechanism (100) according to claim 1, characterized in that; it comprises a lock pin (130) that moves within the interior (163) of the lock body (160) upon moving the lock lever (110) and that allows for unlocking or keeping the hatch (B) locked by transferring said movement to the lock bolt (210).

4. Lock operating mechanism (100) according to claim 1, characterized in that; it comprises o-ring (150) and gasket (170) that are connected to the moving parts and to the mounting positions, and that ensures insulation and sealing between the interior and the exterior of the vehicle (A).

5. Lock operating mechanism (100) according to claim 1, characterized in that; it comprises welding flange (180) that allows for connecting said lock operating mechanism (100) to the vehicle.

6. Lock bolt mechanism (200) according to claim 1, characterized in that; it comprises a locking body (240) that allows for using the lock mechanism in either always-open or always-closed (locked) configurations according to desired scenarios by rotating said lock bolt mechanism (200) 180° around its axis, and slot holes (242) that allows for mounting said locking body (240) easily.

7. Lock bolt mechanism (200) according to claim 1, characterized in that; it comprises a compression spring (220) that applies pressure to the lock bolt (210) by being positioned within the interior (241) of the locking body (240), thereby allowing for using the warfare lock mechanism (C) in always-open or always-closed configurations based on the mounting direction of the lock bolt mechanism (200).

8. Lock bolt mechanism (200) according to claim 1, characterized in that; it comprises a lock bolt (210) that enables the operation of the warfare lock mechanism (C) in always-open or always-closed configurations by means of the compression force received from the compression spring (220), and that allows for opening and closing the hatch (B) upon going into and out of the lock seat (260) based on the motion received from the lock lever (110).

9. Lock bolt mechanism (200) according to claim 1, characterized in that; it comprises big (230) and small (250) bushings that are located within the interior (241) of the locking body (240) and that prevent the lock bolt (210) from wearing out.
